(19) United States
(12) Patent Application Publication
(10) Pub. No.: US 2015/0300528 A1
(43) Pub. Date: Oct. 22, 2015

(54) METHOD FOR THE TRENCHLESS LAYING OF A PIPELINE

(71) Applicant: Rhône Trade and Consulting SA, Sion (CH)

(72) Inventor: Hans-Jürgen John, Anzere (CH)

(73) Assignee: Rhône Trade and Consulting SA, Sion (CH)

(21) Appl. No.: 14/687,774

(22) Filed: Apr. 15, 2015

(30) Foreign Application Priority Data
Apr. 16, 2014 (DE) 102014005567.1

(51) Int. Cl. F16L 1/028; F16L 1/11; F16L 1/036

(52) U.S. Cl. CPC F16L 1/028; F16L 1/036; F16L 1/11

(57) ABSTRACT

A method is disclosed for the trenchless laying of a pipeline, the medium pipe, from a starting location to a target location. First of all a protective pipe is introduced into the ground between the starting location and the target location in a trenchless method. A medium pipe whose outside diameter is smaller than the inside diameter of the protective pipe is introduced into the protective pipe starting from the starting location and moved forward as far as the target location. The medium pipe is stabilized in its spatial position with respect to the protective pipe in the radial direction. The protective pipe is finally removed from the ground again while maintaining the spatial position of the medium pipe.

### CROSS-REFERENCE TO RELATED APPLICATION

The present application claims priority from German Patent Application No. DE 10 2014 005 567.1, filed Apr. 16, 2014, the entirety of which is hereby incorporated by reference herein.

### BACKGROUND OF THE INVENTION

1. Field of the Invention

The invention relates to a method for the trenchless laying of a pipeline in the ground.

2. Discussion of the Prior Art

Pipelines of all types which carry a medium, such as, for example, gas, water or oil, and are therefore referred to hereinbelow as medium pipes, are laid in some cases without a trench. In this regard, the present state of the art makes use of pipe advancement methods such as microtunnelling, EasyPipe (see for example WO 2006/119797 A1), DirectPipe (see for example WO 2009/095046 A1), EasyLong or HDD (Horizontal Directional Drilling). In all of these methods, the medium pipe to be laid is pulled or pushed through a drilled passage into the final position. Here, frictional forces act on the pipe casing and the corrosion protection and can partially damage them. Breaches of the pipe passage caused by instabilities such as gravel pockets, stones or pieces of rock can also compromise the outer side of the pipe. In the DirectPipe method, the pipe advancement forces are even transmitted to the pipe via the pipe casing. Here, there occur high shear forces which subject the assembly of pipe, casing bond and casing to high stress.

### SUMMARY

It is an object of the invention to provide a method for the trenchless laying of pipelines or medium pipes in which the outer side of the pipe is not damaged. This object is achieved by a method for the trenchless laying of a pipeline in ground, the pipeline being a medium pipe, from a starting location to a target location. First of all a protective pipe having an inside diameter that is larger than an outside diameter of the medium pipe is introduced into the ground between the starting location and the target location in a trenchless method. Starting from the starting location, the medium pipe is inserted into the protective pipe and moved forward as far as the target location. The medium pipe is stabilized in a spatial position with respect to the protective pipe in a radial direction. The protective pipe is removed from the ground while maintaining the spatial position of the medium pipe.

In more detail, the method according to the invention is a method for the trenchless laying of a pipeline, the medium pipe, in the ground (for example passing through below an obstacle) from a starting location to a target location. Here, first of all a protective pipe whose inside diameter is larger than the outside diameter of the medium pipe is introduced into the ground between the starting location and the target location in a trenchless method. For this purpose, any known and suitable method can be used, for example one of the pipe advancement methods mentioned at the outset. The starting point for this can be the starting location but also the target location. Accordingly, starting from the starting location, the medium pipe is inserted into the protective pipe and moved forward as far as the target location. The terms “starting location” and “target location” are here by definition used with respect to the direction of movement of the medium pipe. The medium pipe is stabilized in its spatial position with respect to the protective pipe in the radial direction. Finally, the protective pipe is removed from the ground again. Here, the spatial position of the medium pipe is maintained unchanged as far as possible. In other words, the medium pipe is held fixedly in the longitudinal direction (i.e. in its laying direction) such that it is not displaced when removing the protective pipe. Moreover, it is also ensured that the position of the medium pipe is not significantly changed in the radial direction, with the result that the medium pipe is not damaged when removing the protective pipe.

In the method according to the invention, the medium pipe is thus laid in a protective pipe. Therefore, the medium pipe does not come into contact with the inner side of a drilled passage, with the result that damage to the outer side of the medium pipe, for example to a corrosion protection coating, can be reliably avoided. After laying the medium pipe, the protective pipe is removed from the ground again and can be subsequently reused at another location, thereby considerably lowering the costs of the method. The method also offers the possibility of configuring the reusable protective pipe to be particularly robust, with the result that it can be laid more quickly if required without the material costs for the protective pipe overall being crucial.

In advantageous embodiments of the invention, the medium pipe is stabilized in the radial direction in the protective pipe by means of spacers. The spacers support the medium pipe on the inner side of the protective pipe and prevent the outer side of the medium pipe from being damaged when inserting the medium pipe into the protective pipe or when removing the protective pipe. In addition, the spacers allow the medium pipe to extend in a defined manner, with the result that excessive bending of the medium pipe in the longitudinal direction can be avoided. The spacers can be arranged at suitable distances from one another in the longitudinal direction of the medium pipe. A suitable material for the spacers is, for example, plastic, resulting in a low degree of friction between the spacer and the inner side of the protective pipe.

The interspace between the medium pipe and the protective pipe may be empty. It may also be filled with a filling material which has slip capacity with respect to the inner side of the protective pipe, being filled for example with Dämmer and/or bentonite. This has the advantage that a large cavity does not remain outside the medium pipe after removing the protective pipe from the ground. The amount of filling material to be introduced is preferably calculated beforehand from the volume of the interspace between medium pipe and protective pipe. A cavity outside the medium pipe that remains after removing the protective pipe may be filled if required with a filling material, for example with Dämmer or bentonite, also with addition of binders. A binder-enriched bentonite is particularly suitable. Such filling or solidifying materials and their processing and introduction into cavities are known in the prior art. Afterwards, the medium pipe is firmly embedded in the ground and securely at a defined point without ever having been compromised by the drilled passage during installation.

The medium pipe can be assembled in a manner known from the prior art. For example, it may be composed of sections, wherein a section to be added in each case is attached outside the protective pipe to an already present run of sections, preferably by welding. Thus, the medium pipe can be extended section by section and moved into the protective pipe, for example in a construction pit at the starting location. However, it is also conceivable for even a relatively long run of a medium pipe to be prepared at the (or ahead of the) starting location and then to be moved as a whole into the protective pipe. The medium pipe can, for example, be pushed into the protective pipe from the starting location or else be pulled into the protective pipe with the aid of a pulling device mounted at the target location. A floating-into-place operation, in which the protective pipe is partially filled with a buoyancy aid (preferably water), on which the medium pipe floats, is also conceivable.

It may be advantageous for the medium pipe to be periodically ballasted during insertion into the protective pipe and movement forward in the protective pipe, in particular during a downwardly directed movement or to compensate for buoyancy in a buoyancy aid, for example with weights, chains or liquids.

If the protective pipe is large enough to receive a plurality of medium pipes arranged next to one another, the method according to the invention can also be carried out with a plurality of medium pipes. In this case, after laying the protective pipe, the medium pipes can be inserted into or moved forward in the protective pipe simultaneously or after one another. Finally, the protective pipe is removed.

### BRIEF DESCRIPTION OF THE DRAWING FIGURES

The invention will be described in more detail below with reference to an exemplary embodiment. In the drawings:

FIG. 1 shows a schematic sectional view of a protective pipe laid in the ground without a trench, said pipe passing through below an obstacle,

FIG. 2 shows a schematic illustration of how a medium pipe is laid in the protective pipe from FIG. 1,

FIG. 3 shows a cross section through the medium pipe with spacers arranged thereon,

FIG. 4 shows a view similar to FIG. 2, wherein the medium pipe has been completely laid,

FIG. 5 shows a schematic illustration of how the protective pipe is removed from the ground, and

FIG. 6 shows a schematic sectional view in which the completely laid medium pipe is represented.

### DETAILED DESCRIPTION OF THE PREFERRED EMBODIMENTS

In the exemplary embodiment explained below, a pipeline, which is referred to as a “medium pipe”, is laid without a trench, specifically in the exemplary embodiment as a pipe passing through below an obstacle H represented as a river.

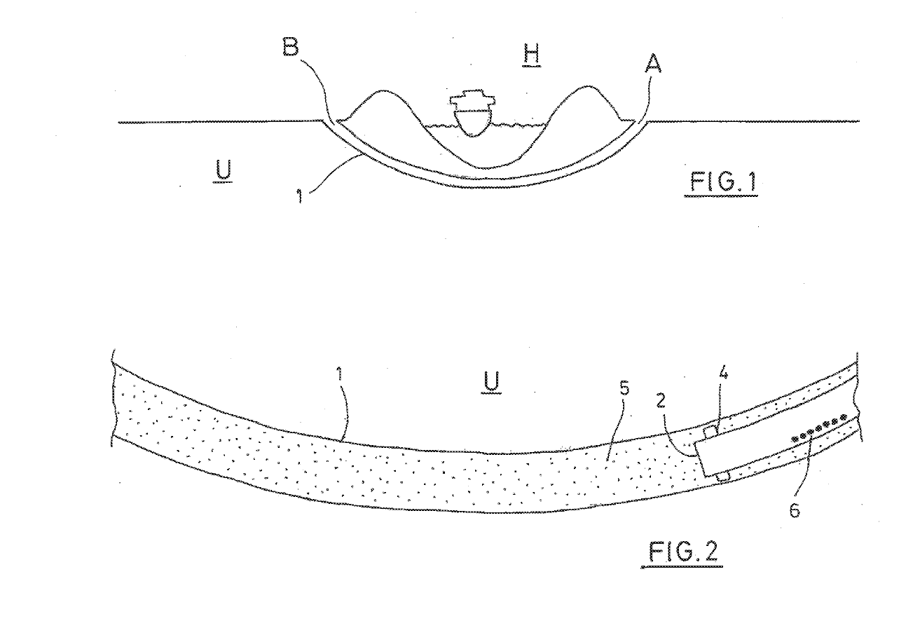

FIG. 1 shows a state in which a protective pipe 1 has already been introduced into the ground, designated by U, while passing through under the obstacle H. The protective pipe 1 extends between a starting location A and a target location B.

There are many pipe-laying possibilities which are known from the prior art and therefore do not have to be explained in more detail. For example, the protective pipe can be introduced with the aid of a directional pipe advancement from the starting location A to the target location B or else starting from the target location B to the starting location A. Here, for example, a cutting device, which is driven to produce a rotational movement, can be mounted on the front pipe end, if appropriate via an intermediate piece, while the protective pipe 1 is pushed forward from the rear pipe end and lengthened in sections. In the exemplary embodiment, the protective pipe 1 is formed as a welded construction made up of steel pipes.

In the representation shown in FIG. 1, the starting location A and the target location B are situated on the surface. An arrangement in a respective construction pit is likewise conceivable. What is most favourable for the individual case also depends on the course taken by the medium pipe ahead of and behind the obstacle H.

FIG. 2 illustrates how a medium pipe 2 is introduced into the completely laid protective pipe 1. By definition, the medium pipe 2 is laid from the starting location A to the target location B.

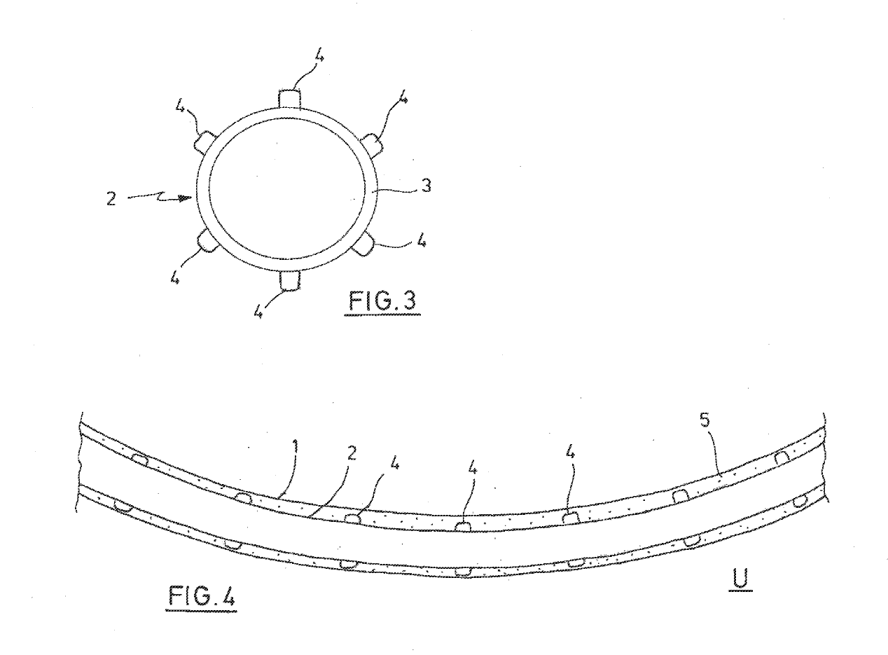

In the exemplary embodiment, the medium pipe 2 is designed as a steel pipe with a pipe wall 3; see FIG. 3. A corrosion protection, which is not damaged during the laying of the medium pipe 2, is applied to the outer side of the pipe wall 3. Therefore, a long service life of the medium pipe is ensured.

As can be seen in FIGS. 2 and 3, spacers 4 are mounted on the pipe wall 3 so as to be distributed around the circumference of the medium pipe 2, with specifically the spacers in the exemplary embodiment consisting of six units which are uniformly distributed. As seen in the longitudinal direction of the medium pipe, the spacers 4 are arranged at more or less regular distances; see also FIG. 4. The spacers ensure that, when introducing the medium pipe 2 into the protective pipe 1, the outer side of the medium pipe 2 cannot come into contact with the inner side of the protective pipe 1, such contact possibly causing the outer coating of the medium pipe 2 to be damaged. In the exemplary embodiment, the spacers 4 are produced from polypropylene, with the result that the frictional forces between the spacers 4 and the pipe wall 3 are low. According to FIG. 3, in each case six spacers 4 are connected with the aid of polypropylene tapes over a circumference of the medium pipe 2, but this is not represented in FIG. 3.

In the exemplary embodiment, the medium pipe 2 is assembled from steel pipe sections from the starting location A, the sections being welded to one another, and is then pushed forward to the target location B. Here, the individual steel pipe sections may, for example, be welded onto the end of the already mounted medium pipe 1, in each case shortly before being inserted into the protective pipe 1. In another possibility, a relatively long section of the medium pipe 2 is already welded together in the terrain ahead of the starting location A. However, what is most cost-effective in the individual case also depends on the terrain.

It is indicated in FIG. 2 that, even before inserting the medium pipe 2 into the protective pipe 1, a filling material 5 can be introduced which subsequently, when the medium pipe 2 is completely laid, is intended to fill the annular space between the medium pipe 2 and the protective pipe 1. Examples of suitable filling material are Dämmer or bentonite or mixtures thereof. In principle, the filling material 5 should not adhere too firmly to the inner side of the pipe wall of the protective pipe 1, since the protective pipe 1 is subsequently removed (see below). The amount of filling material 5 is preferably calculated such that, with the medium pipe 2 completely laid, the aforementioned annular space is completely or virtually completely filled.

FIG. 2 depicts weights 6 which can facilitate the insertion of the medium pipe 2, at least as long as the gradient points downwards.

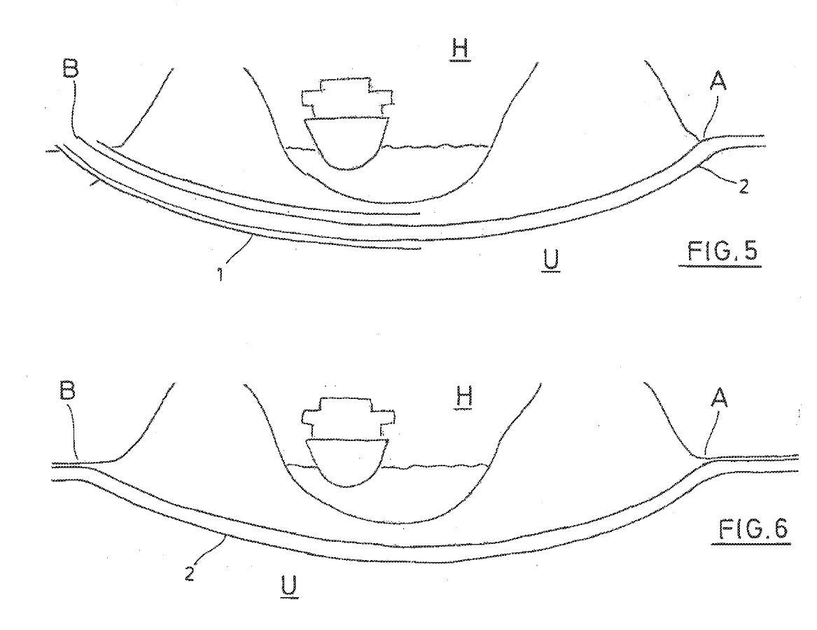

After the medium pipe 2 has been completely laid in the protective pipe 1, see FIG. 4, the protective pipe 1 can be removed. This is because the protective pipe 1, which has substantially facilitated the damage-free laying of the medium pipe 2, is now no longer required to protect the medium pipe 2. In the exemplary embodiment, the protective pipe 1 is pulled away outwardly from the target location B, see FIG. 5, and here dismantled in sections after leaving the ground U. The sections of the protective pipe 1 can be subsequently reused.

If required, a cavity outside the medium pipe 2 that remains after removing the protective pipe 1 from the ground U can be filled with a filling or solidifying material, specifically starting from the starting location A and/or from the target location B. A suitable material for this is, for example, Dämmer or bentonite, also with the use of binders. A binder-enriched bentonite is particularly advantageous, for example.

FIG. 6 shows the medium pipe 2 in the completely laid state. Here, the medium pipe 2 extends ahead of the starting location A and behind the target location B, likewise in the ground U. However, it is also conceivable for the medium pipe to extend above ground in these regions.

What is claimed is:

1. Method for the trenchless laying of a pipeline in ground, the pipeline being a medium pipe, from a starting location to a target location,
wherein first of all a protective pipe having an inside diameter that is larger than an outside diameter of the medium pipe is introduced into the ground between the starting location and the target location in a trenchless method,
wherein, starting from the starting location, the medium pipe is inserted into the protective pipe and moved forward as far as the target location,
wherein the medium pipe is stabilized in a spatial position with respect to the protective pipe in a radial direction, and
wherein the protective pipe is removed from the ground while maintaining the spatial position of the medium pipe.

2. Method according to claim 1, wherein the medium pipe is stabilized in the radial direction in the protective pipe by means of spacers.

3. Method according to claim 2, wherein an interspace between the medium pipe and the protective pipe is filled with a filling material which has slip capacity with respect to an inner side of the protective pipe.

4. Method according to claim 2, wherein, after the removal of the protective pipe from the ground, a remaining cavity outside the medium pipe is filled with a solidifying material.

5. Method according to claim 2, wherein the medium pipe is composed of sections, wherein a section to be added in each case is attached outside the protective pipe to an already present run of said sections.

6. Method according to claim 2, wherein the medium pipe is moved forward in the protective pipe in at least one of the ways selected from the following group: pulling, pushing, floating.

7. Method according to claim 2, wherein, during insertion into the protective pipe and movement forward in the protective pipe, the medium pipe is periodically ballasted.

8. Method according to claim 2, wherein, starting from the starting location, the protective pipe is introduced into the ground towards the target location with a pipe advancement method.

9. Method according to claim 2, wherein, starting from the target location, the protective pipe is introduced into the ground towards the starting location with a pipe advancement method.

10. Method according to claim 2, wherein more than one medium pipe is inserted into the protective pipe and moved forward in the protective pipe, wherein the medium pipes are arranged next to one another.

11. Method according to claim 1, wherein an interspace between the medium pipe and the protective pipe is filled with a filling material which has slip capacity with respect to an inner side of the protective pipe.

12. Method according to claim 11, wherein the filling material comprises at least one of the following materials: Dämmer, bentonite.

13. Method according to claim 1, wherein, after the removal of the protective pipe from the ground, a remaining cavity outside the medium pipe is filled with a solidifying material.

14. Method according to claim 13, wherein the solidifying material comprises at least one of the following materials: Dämmer, bentonite, binder, binder-enriched bentonite.

15. Method according to claim 1, wherein the medium pipe is composed of sections, wherein a section to be added in each case is attached outside the protective pipe to an already present run of said sections.

16. Method according to claim 1, wherein the medium pipe is moved forward in the protective pipe in at least one of the ways selected from the following group: pulling, pushing, floating.

17. Method according to claim 1, wherein, during insertion into the protective pipe and movement forward in the protective pipe, the medium pipe is periodically ballasted.

18. Method according to claim 1, wherein, starting from the starting location, the protective pipe is introduced into the ground towards the target location with a pipe advancement method.

19. Method according to claim 1, wherein, starting from the target location, the protective pipe is introduced into the ground towards the starting location with a pipe advancement method.

20. Method according to claim 1, wherein more than one medium pipe is inserted into the protective pipe and moved forward in the protective pipe, wherein the medium pipes are arranged next to one another.
